(19) United States
(12) Patent Application Publication
(10) Pub. No.: US 2013/0339681 A1
(43) Pub. Date: Dec. 19, 2013

(54) Temporal Multithreading

(71) Applicants: Alex Rocha Prado, Campinas (BR); Celso Fernando Veras Brites, Campinas (BR)

(72) Inventors: Alex Rocha Prado, Campinas (BR); Celso Fernando Veras Brites, Campinas (BR)

(73) Assignee: FREESCALE SEMICONDUCTOR, INC., Austin, TX (US)

(21) Appl. No.: 13/525,494

(22) Filed: Jun. 18, 2012

(51) Int. Cl. G06F 9/312

(52) U.S. Cl. 712/225; 712/E09.033

(57) ABSTRACT

Systems and methods for temporal multithreading are described. In some embodiments, a method may include directing a first instruction received from a first of a plurality of pipeline stages to a first register set storing a first thread context. The method may also include, in response to a command to initiate execution of a second thread, directing a second instruction received from the first of the plurality of pipeline stages to a second register set storing a second thread context while concurrently directing a third instruction received from a second of the plurality of pipeline stages to the first register set. In some embodiments, various techniques disclosed herein may be implemented via a microprocessor, microcontroller, or the like.

### FIELD

This disclosure relates generally to multithreading, and more specifically, to systems and methods of temporal multithreading.

### BACKGROUND

Processors are generally capable of executing one or more sequences of instructions, tasks, or threads. Historically, these instructions were executed in series with respect to each other. Consequently, if a given operation took a long time to complete (e.g., it depended upon the result of an external event), a subsequent operation would have to wait its turn. That was true even if the execution of the latter were independent from the execution of the former, and regardless of whether the processor was otherwise available during its “idle” period. The concept of multithreading or multitasking was developed, in part, to improve the use of available computing resources. Generally speaking, a multithreading or multitasking processor includes hardware support for switching between different instructions, tasks, or threads more efficiently.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of a processor according to some embodiments.

FIG. 2 is a block diagram of a temporal multithreading circuit according to some embodiments.

FIG. 3 is a flowchart of a method of temporal multithreading according to some embodiments.

FIG. 4 is a table illustrating an example of temporal multithreading with four pipeline stages, according to some embodiments.

### DETAILED DESCRIPTION

Embodiments disclosed herein are directed to systems and methods for temporal multithreading. In some implementations, these systems and methods may be applicable to various types of microcontrollers, controllers, microprocessors, processors, central processing units (CPUs), programmable devices, etc., which are generically referred to herein as “processors.” In general, a processor may be configured to perform a wide variety of operations—and may take a variety of forms—depending upon its particular application (e.g., automotive, communications, computing and storage, consumer electronics, energy, industrial, medical, military and aerospace, etc.). Accordingly, as will be understood by a person of ordinary skill in the art in light of this disclosure, the processor(s) described below are provided only for sake of illustration, and numerous variations are contemplated.

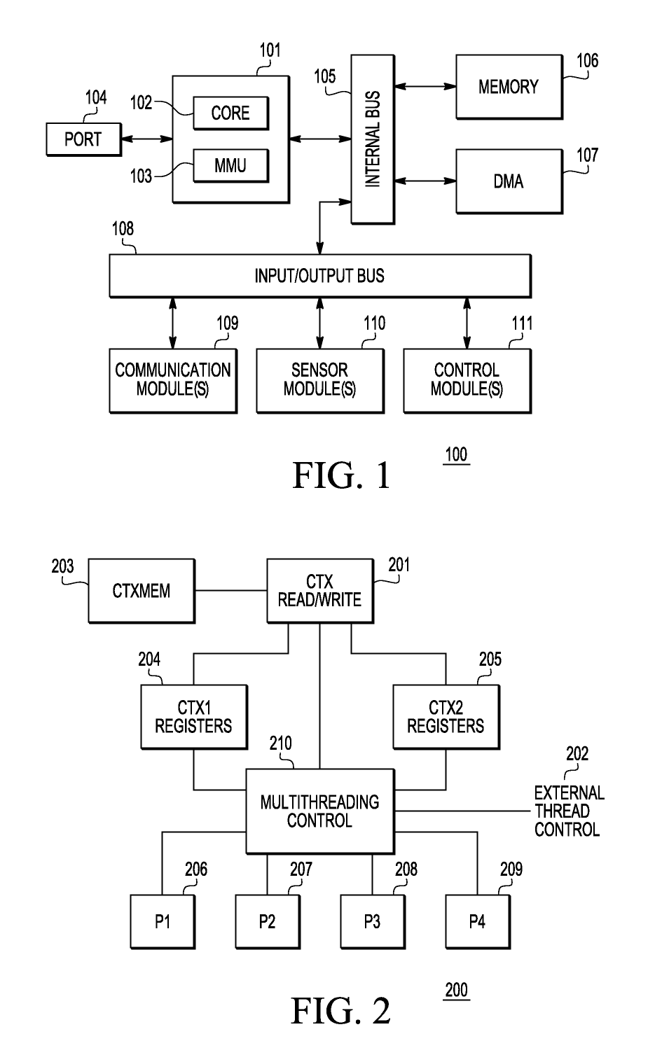

Turning to FIG. 1, a block diagram of processor 100 is depicted according to some embodiments. As shown, processing block 101 includes at least one core 102, which may be configured to execute programs, interrupt handlers, etc. In various embodiments, core 102 may include any suitable 8, 16, 32, 64, 128-bit, etc. processing core capable of implementing any of a number of different instruction set architectures (ISAs), such as the x86, POWERPC®, ARM®, SPARC®, or MIPS® ISAs, etc. In additional or alternative implementations, core 102 may be a graphics-processing unit (GPU) or other dedicated graphics-rendering device. Processing block 101 also includes memory management unit (MMU) 103, which may in turn include one or more translation look-aside buffers (TLBs) or the like, and which may be configured to translate logical addresses into physical addresses. Port controller 104 is coupled to processing block 101 and may allow a user to test processor 100, perform debugging operations, program one or more aspects of processor 100, etc. Examples of port controller 104 may include a Joint Test Action Group (JTAG) controller and/or a Nexus controller. Internal bus 105 couples system memory 106 and Direct Memory Access (DMA) circuit or module 107 to processing block 101. In various embodiments, internal bus 105 may be configured to coordinate traffic between processing block 101, system memory 106, and DMA 107.

System memory 106 may include any tangible or non-transitory memory element, circuit, or device, which, in some cases, may be integrated within processor 100 as one chip. For example, system memory 106 may include registers, Static Random Access Memory (SRAM), Magnetoresistive RAM (MRAM), Nonvolatile RAM (NVRAM, such as “flash” memory), and/or Dynamic RAM (DRAM) such as synchronous DRAM (SDRAM), double data rate (e.g., DDR, DDR2, DDR3, etc.) SDRAM, read only memory (ROM), erasable ROM (EROM), erasable programmable ROM (EPROM), electrically erasable programmable ROM (EEPROM), etc. In some cases, memory 106 may also include one or more memory modules to which the memory devices are mounted, such as single inline memory modules (SIMMs), dual inline memory modules (DIMMs), etc. DMA 107 includes a programmable data transfer circuit configured to effect certain memory operations (e.g., on behalf of modules 109-111) without intervention from processing block 101.

Input/output (I/O) bus 108 is coupled to internal bus 105 (e.g., via a bus interface) as well as communication module(s) 109, sensor module(s) 110, and control module(s) 111. In some embodiments, I/O bus 108 may be configured to coordinate I/O traffic and to perform any protocol, timing, and/or other data transformations to convert data signals from one component (e.g., sensor module(s) 110) into a format suitable for use by another component (e.g., processing block 101). Communication module(s) 109 may include, for example, a Controller Area Network (CAN) controller, a serial, Ethernet, or USB controller, a wireless communication module, etc. Sensor module(s) 110 and control module(s) 111 may include circuitry configured to allow processor 100 to interface with any suitable sensor or actuator (not shown).

Embodiments of processor 100 may include, but are not limited to, application specific integrated circuit (ASICs), system-on-chip (SoC) circuits, digital signal processor (DSPs), processors, microprocessors, controllers, microcontrollers, or the like. As previously noted, different implementations of processor 100 may take different forms, and may support various levels of integration. For example, in some applications, DMA 107 may be absent or replaced with custom-designed memory access circuitry. In other applications, internal bus 105 may be combined with I/O bus 108. In yet other applications, one or more other blocks shown in FIG. 1 (e.g., modules 109-111) may be combined into processing block 101. In various embodiments, processor 100 may be a “multi-core” processor having two or more cores (e.g., dual-core, quad-core, etc.) and/or two or more processing blocks 101. It is noted that elements such as clocks, timers, etc., which are otherwise ordinarily found within processor 100, have been omitted from the discussion of FIG. 1 for simplicity of explanation.

In some embodiments, processor 100 may be employed in real-time, embedded applications (e.g., engine or motor control, intelligent timers, etc.) that benefit from the efficient use of processor 100's processing resources. Additionally or alternatively, processor 100 may be deployed in energy-scarce environments (e.g., in battery or solar-powered devices, etc.) that also benefit from a more efficient use of processing resources. Accordingly, processor 100 may be fitted with elements, circuits, or modules configured to implement one or more temporal multithreading techniques, as described in more detail in connection with FIGS. 2-4.

At this point it is appropriate to note that the term “thread,” as used herein, generally refers to a unit of processing, and that the term “multithreading” refers to the ability of a processor (e.g., processor 100) to switch between different threads, thereby attempting to increase its utilization. In some environments, “units of processing” may be referred to as “tasks” or simply as a “processes,” and therefore it should be understood that one or more of the techniques described herein may also be applicable to “multitasking” or “multiprocessing.” When switching between threads, a processor may also switch between corresponding “contexts.” Generally speaking, a “thread context” is a set of data or variables used by a given thread that, if saved or otherwise preserved, allows the thread to be interrupted—e.g., so that a different thread may be executed—and then continued at a later time (specific data or variables making up a thread context may depend upon the type of processor, application, thread, etc.). As also used herein, the term “pipelining” generally refers to a processor's ability to divide each instruction into a particular sequence of operations or stages (e.g., fetch, decode, etc.) and to execute each stage separately. In some cases, distinct electrical circuits and/or portions of the same processor core (e.g., core 102 in FIG. 1) may be involved in implementing each pipelining stage. Thus, for example, a single processor core may be capable of executing a fetch operation of a first instruction, a decode operation of a second instruction, and an execute operation of a third instruction all concurrently or simultaneously (e.g., during a same clock cycle).

There are two distinct types of multithreading—temporal and simultaneous. In “simultaneous multithreading,” instructions from more than one thread execute in any given pipeline stage at the same time. In “temporal multithreading,” however, a single thread of instructions is executed in a given pipeline stage at a given time.

Turning now to FIG. 2, a block diagram of temporal multithreading circuit 200 is depicted. As illustrated, context memory CTXMEM 203 is coupled to context read/write controller 201, which in turn is coupled to multithreading control engine 210. Context read/write controller 201 and multithreading control engine 210 are both operably coupled to first context register set or bank CTX1 204 and to second context register set or bank CTX2 205. Multithreading control engine 210 is operably coupled to each of a plurality of pipeline stages P1-P4 206-209, as well as external thread control 202. In some embodiments, elements 201, 202, and 204-210 of circuit 200 may be implemented within core 102 of processor 100, shown in FIG. 1. Accordingly, in the case of a multi-core implementation, each of elements 201, 202, and 204-210 of circuit 200 may be repeated within each respective core (so that each such core may perform one or more of the operations described below independently of each other). Context memory CTXMEM 203 may reside outside of core 102 and, in a multi-core implementation, it may be operably coupled to and/or shared among the plurality of cores.

In operation, context memory CTXMEM 203 may be configured to store a plurality of thread contexts under control of context read/write controller 201. For example, context read/write controller 201 may retrieve a thread context from CTXMEM 203 and store it in one of register sets or banks CTX1 204 or CTX2 205, each of which including registers that define a processor's programming model (e.g., pc, sp, r0, . . . , rn, etc.). After the thread context is retrieved and stored in one of register sets CTX1 204 or CTX2 205, pipeline stages P1-P4 206-209 may be capable of executing a given thread based on that thread context. For instance, in some embodiments, first pipeline stage P1 206 may perform a “fetch” operation, second pipeline stage P2 207 may perform a “decode” operation, third pipeline stage P3 208 may perform an “execute” operation, and fourth pipeline stage P4 209 may perform a “write-back” operation. In other embodiments, however, other number of pipeline stages (e.g., 3, 5, 6, etc.) may be used, and different operations may be associated with each stage.

When a thread's execution is complete or otherwise halted (e.g., upon actual completion of the thread, triggering of an interrupt, etc.), context read/write controller 201 may retrieve an updated thread context from a respective one of register sets CTX1 204 or CTX2 205, and it may store the updated context in context memory CTXMEM 203. In various implementations, context memory CTXMEM 203 may be separate from system memory 106 and/or it may be dedicated exclusively to the storage of thread contexts and/or it may be accessible by software.

In some embodiments, multithreading control engine 210 may be configured to control the transit or flow of thread contexts between context memory CTXMEM 203 and register sets CTX1 204/CTX2 205 in response to a signal, command, or indication received from external thread control 202. Examples of external thread control 202 may include sources or events (i.e., context switch events) such as, for instance, hardware or software schedulers, timer overflows, completion of external memory operations, completion of analog to digital conversions, logic level changes on a sensor's input, data received via a communication interface, entering of a sleep or power-saving mode, etc. Multithreading control engine 210 may also be configured to receive messages or instructions (e.g., read and write instructions) from pipeline stages P1-P4 206-209, and to direct each instruction to an appropriate one of register sets CTX1 204 or CTX2 205. Accordingly, pipeline stages P1-P4 206-209 may issue instructions that are context-agnostic—i.e., each pipeline stage may execute instructions without knowing which thread is being executed—because multithreading control engine 210 may be in charge of directing those instructions to an appropriate one between register sets CTX1 204/CTX2 205 at an appropriate time.

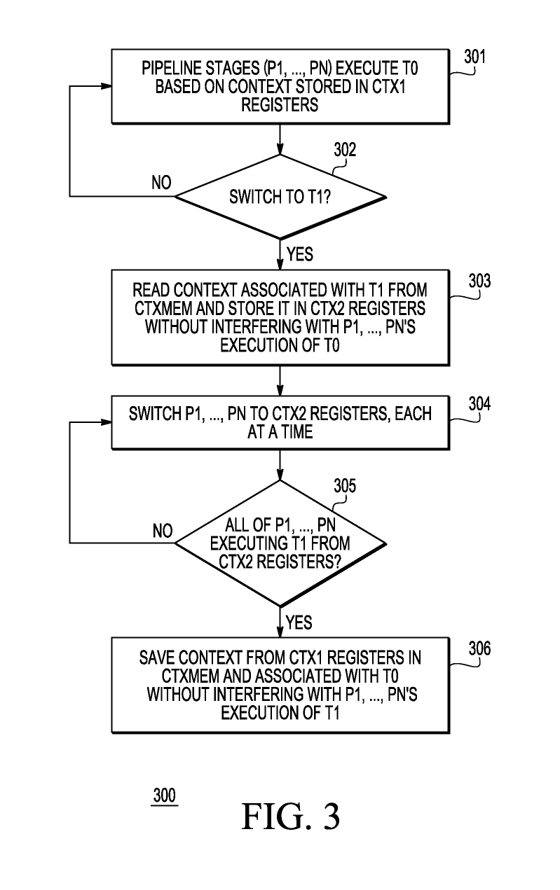

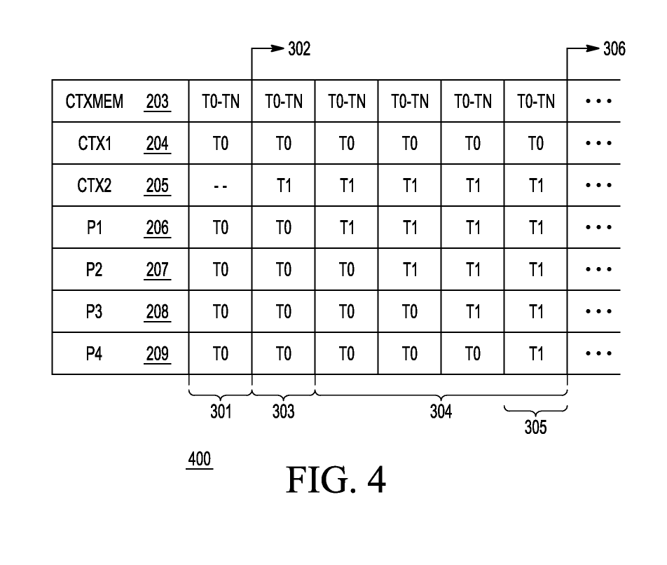

For example, during execution of a first thread, multithreading control engine 210 may direct all instructions received from each pipeline stages P1-P4 206-209 to first register set CTX1 204, and first register set CTX1 204 may be configured to store a first thread context corresponding to the first thread. In response to a command received from external thread control 202 to switch execution to a second thread, multithreading control engine 210 may cause context read/write controller 201 to retrieve a second thread context (corresponding to the second thread) from context memory CTXMEM 203, and to store that second thread context in second register set CTX2 205. In some cases, this retrieve and store operation may occur without interruption of the first thread, which continues to execute based on the contents of first register set CTX1 204. Then, multithreading control engine 210 may direct an instruction from first pipeline stage P1 206 to second register set CTX2 205 to thereby begin execution of the second thread. Moreover, instructions already in the pipeline may continue to execute after the second thread has begun. For instance, multithreading control engine 210 may direct an instruction from second pipeline state P2 207 to first register set CTX1 204 to continue execution of the first thread. These, as well as other operations, are described in more detail below with respect to FIGS. 3 and 4.

In some embodiments, the modules or blocks shown in FIG. 2 may represent processing circuitry and/or sets of software routines, logic functions, and/or data structures that, when executed by the processing circuitry, perform specified operations. Although these modules are shown as distinct blocks, in other embodiments at least some of the operations performed by these blocks may be combined in to fewer blocks. For example, in some cases, context read/write controller 201 may be combined with multithreading control engine 210. Conversely, any given one of modules 201-210 may be implemented such that its operations are divided among two or more blocks. Although shown with a particular configuration, in other embodiments these various modules or blocks may be rearranged in other suitable ways.

FIG. 3 is a flowchart of a method of temporal multithreading. In some embodiments, method 300 may be performed at least in part, by temporal multithreading circuit 200 of FIG. 2 within core 102 of processor 100 in FIG. 1. At block 301, a plurality of pipeline stages P1-P4 206-209 execute a first thread T0 based on thread context data and/or variables stored in a first register set CTX1 204. At block 302, method 300 determines whether to switch to the execution of a second thread T1. For example, as noted above, external thread control 202 may transmit a command specifically requesting the thread or context switch to T1. If not, control returns to block 302. Otherwise control passes to block 303.

At block 303, method 300 reads thread context data and/or variables associated with second thread T1 from context memory from CTXMEM 203, and stores it in second register set CTX2 205. The process of block 303 may occur under control of temporal multithreading circuit 200 and without interfering with the execution of first thread T0 between pipeline stages P1-P4 206-209 and first register set CTX1 204. In other words, while context read/write controller 201 retrieves T1's thread context from context memory CTXMEM 203 and stores it in second register set CTX2 205, temporal multithreading circuit 210 may continue to direct or send one or more instructions from pipeline stages P1-P4 206-209 to first register set CTX1 204.

At block 304, method 300 may switch each of the plurality of pipeline stages P1-P4 206-209 to execute second thread T1 based on the thread context data and/or variables newly stored in second register set CTX2 205. To achieve this, temporal multithreading circuit 200 may direct, send, or transmit instructions received from each of pipeline stages P1-P4 206-209 to second register set CTX2 205—i.e., instead of first register set CTX1 204. Moreover, the process of block 304 may be implemented such that each pipeline stage is switched from T0 to T1 one at a time (e.g., first P1 206, then P2 207, followed by P3 208, and finally P4 209). Pipeline stages that have not switched to the second thread T1 during this process may continue to have one or more instructions directed to first register set CT1 204 (independently and/or in the absence of a command to resume and/or continue execution of the first thread T0).

For example, a first instruction received from first pipeline stage P1 206 may be directed to second register set CTX2 205, and a second instruction received from second pipeline stage P2 207 concurrently with or following (e.g., immediately following) the first instruction may be directed to first register set CTX1 204. Then, in a subsequent clock cycle(s), a third instruction received from second pipeline stage P2 207 may be directed to second register set CTX2 205, and a fourth instruction received from third pipeline stage P3 208 concurrently with or following (e.g., immediately following) the third instruction may be directed to first register set CTX1 204. The process may then continue in a cascaded manner until all pipeline stages have switched to the execution of second thread T1—i.e., until all instructions are directed to second register set CTX2 205.

At block 305, method 300 determines whether all pipeline stages have switched to the execution of second thread T1. It not, control returns to block 304. Otherwise, control passes to block 306. At block 306, method 300 saves the last updated version of the first thread context data and/or variables, still stored in first register set CTX1 204, to context memory CTXMEM 203. Similarly as explained above, the process of block 306 may occur without interfering with the execution of the second thread T1 between P1-P4 206-209 and second register set CTX2 205.

It should be understood that, in several applications, method 300 may be repeated to support subsequent thread context switches. For example, after block 306 and in response to another command to switch to execution to another thread, method 300 may determine whether the other thread is the same as T0, in which case there is no need to retrieve the corresponding thread context from context memory CTXMEM 203 (it is still available in first register set CTX1 204). Then, method 300 may switch the execution of each pipeline stage P1-P4 206-209, one at a time, back to first register set CTX1 204. For example, first pipeline stage P1 206 may have an instruction directed to first register set CTX1 204 to resume execution of T0, while second pipeline stage P2 207 may have a subsequent instruction directed to second register set CTX2 205 to continue execution of T1—and so on, until all pipeline stages P1-P4 206-209 have switched back to T0.

On the other hand, in the more general case where the other thread is in fact a third thread (T2) that is different from T0 (and T1), a corresponding thread context may be retrieved from context memory CTXMEM 203 and stored in first register set CTX1 204, thus replacing the thread context of first thread T0 previously residing in CTX1 204, and without interrupting execution of second thread T1 between pipeline stages P1-P4 206-209 and second register set CTX2 205. Again, method 300 may switch the execution of each pipeline stage P1-P4 206-209, one at a time, to first register set CTX1 204. For example, first pipeline stage P1 206 may have an instruction directed to first register set CTX1 204 to initiate execution of third thread T2, while second pipeline stage P2 207 has a subsequent instruction directed to second register set CTX2 205 to continue execution of second thread T1—and so on, until all stages have switched to T2.

To further illustrate method 300, FIG. 4 depicts table 400 showing an example of temporal multithreading with four pipeline stages according to some embodiments. Each column in table 400 represents one or more clock cycles, and has retained a number that corresponds to a respective block in method 300 for ease of explanation. At column 301, all pipeline stages P1-P4 206-209 are shown executing first thread T0 based upon a corresponding thread context stored in first register set CTX1 204. Second register set CTX2 205 is empty and/or its initial state may not be relevant. Block 302 of FIG. 3 is illustrated in table 400 as taking place between columns 301 and 303, when external thread control 202 transmits a command to multithreading control engine 210 requesting a switch from first thread T0 to second thread T1.

Sometime after having received the context switch command (e.g., after one or more clock cycle(s)), column 303 shows that a thread context corresponding to second thread T1 has been stored in second register set CTX2 205, while pipeline stages P1-P4 206-209 are still executing first thread T0 based on the thread context stored in first register set CTX1 204. In other words, as noted above, the thread context of second thread T1 may be retrieved from context memory CTXMEM 203 and stored in second register set CTX2 205 without interfering with the execution of first thread T0.

Columns 304 show each of pipeline stages P1-P4 206-209 being sequentially switched from T0 to T1 in a cascaded fashion under control of multithreading control engine 210. Specifically, at a first clock cycle(s) within columns 304, only first pipeline stage P1 206 has its instruction(s) directed to second register set CTX2 205, but subsequent pipeline stages P2-P4 207-209 still have their instructions directed to first register set CTX1 204 by multithreading control engine 210. This may occur without there have been an explicit command or request that pipeline stages P2-P4 continue execution of first thread T0. Because this example involves four pipeline stages, it may take four clock cycles for all pipeline stages to complete their transitions to second thread T1. This is shown in column 305, where all of P1-P4 206-209 are executing second thread T1 based on the thread context stored in second register set CTX2 205. Here it should be noted that, during at least a portion of the context switching operation, both first and second thread T0 and T1 are being executed simultaneously, concurrently, or in parallel under control of multithreading control engine 210. As such, neither of T0 or T1's execution is interrupted by the switching operation, which in many cases may result in the more effective use of processor resources.

Still referring to FIG. 4, context memory CTXMEM 203 is shown in table 400 as storing a plurality of thread contexts T0-TN at all times. However, context memory CTXMEM 203 does not have the most up-to-date version of all thread contexts all the time. For example, context memory CTXMEM 203 does not have the latest context corresponding to first thread T0 while T0 is being executed by one or more of pipeline stages P1-P4 206-209 (i.e., during the clock cycles shown between column 301 and the next-to-last column in 304). But at column 305 first thread T0 is no longer being executed by any pipeline stage. Therefore, block 306 is also represented in table 400 as illustrating multithreading control engine 210's command to context read/write controller 201 to retrieve the updated thread context for T0 from first register set CTX1 204 and to store it in context memory CTXMEM 203. Similarly, context memory CTXMEM 203 does not have the most up-to-date version of second thread T1 while T1 is being executed by one or more of pipeline stages P1-P4 206-209—i.e., during the clock cycles shown in columns 304. After a subsequent context switching operation (not shown), an updated version of T1 may also be stored in context memory CTXMEM 203.

It should be understood that the various operations explained herein, particularly in connection with FIGS. 3 and 4, may be implemented in software executed by processing circuitry, hardware, or a combination thereof. The order in which each operation of a given method is performed may be changed, and various elements of the systems illustrated herein may be added, reordered, combined, omitted, modified, etc. It is intended that the invention(s) described herein embrace all such modifications and changes and, accordingly, the above description should be regarded in an illustrative rather than a restrictive sense.

As described above, in some embodiments, some of the systems and methods described herein may provide a processor configured to executes many threads, via hardware-switching, and using only two context register sets. Other embodiments may include more context register sets. Moreover, the processor uses two thread contexts during at least one or more of the same clock cycles—i.e., in concurrently, simultaneously, or in parallel. Accordingly, pipeline stages within such a processor may therefore remain busy, even during context switch operations, thus improving its utilization and efficiency. A separate memory (e.g., context memory CTXMEM 203) may be used for context saving, and it may be invisible to the programming or software model, thus not interfering with its execution.

In some cases, a large number of thread contexts may be stored in a dedicated context memory at a small design or silicon cost (e.g., RAM has a relatively small footprint and/or power requirements), thus reducing the need for relatively more expensive components (e.g., in an embodiment, only two register sets CTX1 204 and CTX2 205 may be employed, which generally have a large footprint and/or power requirements per context compared to context memory CTXMEM 203), as well as reducing the costs of running two or more threads. Moreover, a pair of register sets CTX1 204 and CTX2 205 may be both accessed by the execution pipeline stages P1-P4 206-209 concurrently, simultaneously, or in parallel during at least a portion of the context switching operation, and both may be either source or target for context save/restore operation(s). As a person of ordinary skill in the art will recognize in light of this disclosure, these and other features may enable a more efficient use of processor resources and/or electrical power.

In an illustrative, non-limiting embodiment, a method may include directing a first instruction received from a first of a plurality of pipeline stages to a first register set storing a first thread context, and, in response to a command to initiate execution of a second thread, directing a second instruction received from the first of the plurality of pipeline stages to a second register set storing a second thread context while concurrently directing a third instruction received from a second of the plurality of pipeline stages to the first register set. In some implementations, the plurality of pipeline stages may include at least one of: a fetch stage, a decode stage, an execute stage, or a write-back stage. Moreover, the one or more instructions may include at least one of: a read instruction or a write instruction.

In some embodiments, the method may include executing the second instruction by the first of the plurality of pipeline stages and executing the third instruction by the second of the plurality of pipeline stages both during a transition between execution of the first and second threads. Prior to having directed the second instruction, the method may include causing the second thread context to be retrieved from a context memory and stored in the second register set while directing one or more additional instructions from one or more of the plurality of pipeline stages to the first register set. The method may also include, after having directed the second and third instructions, directing a fourth instruction received from the second of the plurality of pipeline stages to the second register set while concurrently directing a fifth instruction received from a third of the plurality of pipeline stages to the first register set. The method may further include causing a context memory to be updated with a current first thread context in response to a determination that instructions received from all of the plurality of pipeline stages are being directed to the second register set.

In response to a command to initiate execution of a third thread, the method may include causing a third thread context to be retrieved from a context memory and to replace the first thread context in the first register set and directing a fourth instruction received from the first of the plurality of pipeline stages to the first register set while concurrently directing a fifth instruction received from the second of the plurality of pipeline stages to the second register set. The method may also include causing a context memory to be updated with a current second thread context in response to a determination that instructions received from all of the plurality of pipeline stages are being directed to the first register set.

In another illustrative, non-limiting embodiment, a processor core may include a first and second register sets and control circuitry operably coupled to the first and second register sets. Moreover, the control circuitry may be configured to direct instructions received from a plurality of pipeline stages to one of the first or second register sets to allow the plurality of pipeline stages to execute a first thread based on a first thread context stored in the one of the first or second register sets, cause a second thread context corresponding to the second thread to be stored in the other one of the first or second register sets in response to a command to switch execution to a second thread, and direct a first instruction received from a first of the plurality of pipeline stages to the other one of the first or second register sets to begin execution of the second thread, at least in part, while a second of the plurality of pipeline stages continues execution of the first thread based on the first thread context stored in the one of the first or second register sets.

In some implementations, the plurality of pipeline stages may include three or more stages, and the control circuit may be configured to direct a second instruction received from the second of the plurality of pipeline stages to the other one of the first or second register sets to continue execution of the second thread, at least in part, while a third of the plurality of pipeline stages continues execution of the first thread based on the first thread context stored in the one of the first or second register sets. The control circuitry may be further configured to update a context memory with a current first thread context stored in the first register set after each of the plurality of pipeline stages has switched execution to the second thread.

In some embodiments, the processor core may include a context read/write circuitry operably coupled to the control circuitry, a context memory, and the first and second register sets, the context read/write circuitry configured to retrieve a thread context from the context memory and store it in the first or second register set under control of the control circuitry, the context read/write circuitry further configured to retrieve a thread context from the first or second register set and store it in the context memory under control of the control circuitry. The control circuitry may be further configured to cause the context read/write circuitry to update the context memory with a current first thread context stored in the one of the first or second register sets after each of the plurality of pipeline stages has switched execution to the second thread.

In response to a command to switch execution to a third thread, the control circuitry may be configured to cause the context read/write circuitry to retrieve a third thread context corresponding to the third thread from the context memory and to store the third thread context in the one of the first or second register sets; and to direct a second instruction received from the first of the plurality of pipeline stages to the first register set to initiate execution of the third thread, at least in part, while the second of the plurality of pipeline stages continues execution of the second thread. The control circuitry may be further configured to cause the context read/write circuitry to update the context memory with a current second thread context stored in the other one of the first or second register sets after each of the plurality of pipeline stages has switched execution to the third thread.

In yet another illustrative, non-limiting embodiment, an integrated circuit may include one or more processor cores, and each of the one or more processor cores may include a first and second context register sets, each of the context register sets adapted to store any given one of the plurality of thread contexts, as well as control circuitry operably coupled to the first and second context register sets, the control circuitry adapted to enable execution of a first thread based on a first of the plurality of thread contexts stored in one of the first or second context register sets, to enable execution of a second thread based on a second of the plurality of thread contexts stored in the other of the first or second context register sets in response to a context switch event, and to enable continued execution of the first thread based on the first of the plurality of thread contexts stored in the one of the first or second context register sets while the second thread is being executed and in the absence of another context switch event.

In some implementations, the control circuitry may be adapted to cause the second thread context to be retrieved from a context memory and stored in the other of the first or second context register sets, the context memory operably coupled to the one or more processor cores and adapted to store a plurality of thread contexts. Also, to enable execution of the second thread, the control circuitry may be adapted to direct a first instruction received from a first of a plurality of pipeline stages to the other of the first or second context register sets. Moreover, to enable continued execution of the first thread, the control circuitry may be further adapted to direct a second instruction received from a second of the plurality of pipeline stages to the one of the first or second context register sets.

In some embodiments, the control circuitry may be adapted to direct a third instruction received from the second of the plurality of pipeline stages to the other of the first or second context register sets to enable continued execution of the second thread, and to direct a fourth instruction received from a third of the plurality of pipeline stages to the one of the first or second context register sets to enable continued execution of the first thread. The control circuitry may also be adapted to cause a third thread context to be retrieved from the context memory and stored in the one of the first or second context register sets in response to an indication to initiate execution of a third thread, and to enable continued execution of the second thread based on the second of the plurality of thread contexts stored in the other of the first or second context register sets while the third thread is being executed and in the absence of another context switch event.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as connected, although not necessarily directly, and not necessarily mechanically. The terms “a” and “an” are defined as one or more unless stated otherwise. The terms “comprise” and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
directing a first instruction received from a first of a plurality of pipeline stages to a first register set storing a first thread context; and
in response to a command to initiate execution of a second thread, directing a second instruction received from the first of the plurality of pipeline stages to a second register set storing a second thread context while concurrently directing a third instruction received from a second of the plurality of pipeline stages to the first register set.

2. The method of claim 1, further comprising executing the second instruction by the first of the plurality of pipeline stages and executing the third instruction by the second of the plurality of pipeline stages both during a transition between execution of the first and second threads.

3. The method of claim 1, further comprising, prior to having directed the second instruction, causing the second thread context to be retrieved from a context memory and stored in the second register set while directing one or more additional instructions from one or more of the plurality of pipeline stages to the first register set.

4. The method of claim 1, further comprising, after having directed the second and third instructions, directing a fourth instruction received from the second of the plurality of pipeline stages to the second register set while concurrently directing a fifth instruction received from a third of the plurality of pipeline stages to the first register set.

5. The method of claim 4, further comprising causing a context memory to be updated with a current first thread context in response to a determination that instructions received from all of the plurality of pipeline stages are being directed to the second register set.

6. The method of claim 1, further comprising:
in response to a command to initiate execution of a third thread, causing a third thread context to be retrieved from a context memory and to replace the first thread context in the first register set; and
directing a fourth instruction received from the first of the plurality of pipeline stages to the first register set while concurrently directing a fifth instruction received from the second of the plurality of pipeline stages to the second register set.

7. The method of claim 6, further comprising causing a context memory to be updated with a current second thread context in response to a determination that instructions received from all of the plurality of pipeline stages are being directed to the first register set.

8. A processor core, comprising:
a first and second register sets; and
control circuitry operably coupled to the first and second register sets, the control circuitry configured to:
direct instructions received from a plurality of pipeline stages to one of the first or second register sets to allow the plurality of pipeline stages to execute a first thread based on a first thread context stored in the one of the first or second register sets, cause a second thread context corresponding to the second thread to be stored in the other one of the first or second register sets in response to a command to switch execution to a second thread, and direct a first instruction received from a first of the plurality of pipeline stages to the other one of the first or second register sets to begin execution of the second thread, at least in part, while a second of the plurality of pipeline stages continues execution of the first thread based on the first thread context stored in the one of the first or second register sets.

9. The processor core of claim 8, the plurality of pipeline stages including three or more stages.

10. The processor core of claim 8, the control circuitry further configured to direct a second instruction received from the second of the plurality of pipeline stages to the other one of the first or second register sets to continue execution of the second thread, at least in part, while a third of the plurality of pipeline stages continues execution of the first thread based on the first thread context stored in the one of the first or second register sets.

11. The processor core of claim 8, further comprising:
a context read/write circuitry operably coupled to the control circuitry, a context memory, and the first and second register sets, the context read/write circuitry configured to retrieve a thread context from the context memory and store it in the first or second register set under control of the control circuitry, the context read/write circuitry further configured to retrieve a thread context from the first or second register set and store it in the context memory under control of the control circuitry.

12. The processor core of claim 11, the control circuitry further configured to cause the context read/write circuitry to update the context memory with a current first thread context stored in the one of the first or second register sets after each of the plurality of pipeline stages has switched execution to the second thread.

13. The processor core of claim 11, the control circuitry further configured to:
in response to a command to switch execution to a third thread, cause the context read/write circuitry to retrieve a third thread context corresponding to the third thread from the context memory and to store the third thread context in the one of the first or second register sets; and
direct a second instruction received from the first of the plurality of pipeline stages to the first register set to initiate execution of the third thread, at least in part, while the second of the plurality of pipeline stages continues execution of the second thread.

14. The processor core of claim 13, the control circuitry further configured to cause the context read/write circuitry to update the context memory with a current second thread context stored in the other one of the first or second register sets after each of the plurality of pipeline stages has switched execution to the third thread.

15. An integrated circuit, comprising:
one or more processor cores, each of the one or more processor cores including:
a first and second context register sets, each of the context register sets adapted to store any given one of the plurality of thread contexts; and
control circuitry operably coupled to the first and second context register sets, the control circuitry adapted to enable execution of a first thread based on a first of the plurality of thread contexts stored in one of the first or second context register sets, to enable execution of a second thread based on a second of the plurality of thread contexts stored in the other of the first or second context register sets in response to a context switch event, and to enable continued execution of the first thread based on the first of the plurality of thread contexts stored in the one of the first or second context register sets while the second thread is being executed and in the absence of another context switch event.

16. The integrated circuit of claim 15, wherein the control circuitry is further adapted to cause the second thread context to be retrieved from a context memory and stored in the other of the first or second context register sets, the context memory operably coupled to the one or more processor cores and adapted to store a plurality of thread contexts.

17. The integrated circuit of claim 15, wherein to enable execution of the second thread, the control circuitry is further adapted to direct a first instruction received from a first of a plurality of pipeline stages to the other of the first or second context register sets.

18. The integrated circuit of claim 17, wherein to enable continued execution of the first thread, the control circuitry is further adapted to direct a second instruction received from a second of the plurality of pipeline stages to the one of the first or second context register sets.

19. The integrated circuit of claim 18, wherein the control circuitry is further adapted to direct a third instruction received from the second of the plurality of pipeline stages to the other of the first or second context register sets to enable continued execution of the second thread, and to direct a fourth instruction received from a third of the plurality of pipeline stages to the one of the first or second context register sets to enable continued execution of the first thread.

20. The integrated circuit of claim 19, wherein the control circuitry is further adapted to cause a third thread context to be retrieved from a context memory and stored in the one of the first or second context register sets in response to an indication to initiate execution of a third thread, the context memory operably coupled to the one or more processor cores and adapted to store a plurality of thread contexts, and the control circuitry further adapted to enable continued execution of the second thread based on the second of the plurality of thread contexts stored in the other of the first or second context register sets while the third thread is being executed and in the absence of another context switch event.
